(19) United States
(12) Patent Application Publication
(10) Pub. No.: US 2014/0266872 A1
(43) Pub. Date: Sep. 18, 2014

(54) Space Needles

(71) Applicant: Hackproof Technologies Inc., St. Augustine, FL (US)

(72) Inventor: Joseph Mitola, III, Saint Augustine, FL (US)

(21) Appl. No.: 13/832,734

(22) Filed: Mar. 15, 2013

(51) Int. Cl. B64G 1/10; H04B 7/19; H04B 7/01

(52) U.S. Cl. CPC B64G 1/1007; H04B 7/01; H04B 7/19
USPC 342/356

(57) ABSTRACT

A conical region in space with a base at a geosynchronous distance from the earth and the apex of the cone at a point on the ground may be termed a space needle. A multiplicity of small satellites in elliptical orbits located within such a space needle may establish timing of their radio frequency (RF) transmissions forming what may be termed a needle beam downlink having an apparent origin that may be thousands of kilometers to the North or South of a Kepler geosynchronous satellite parking orbit. A noise-like RF signal may be transmitted synchronously from multiple transmitters in space forming a spatially distributed spread spectrum RF needle beam. Applying the method of space-based needle beams to a multiplicity of transmitters on the ground, a network of ground stations may form a ground-based needle beam uplink that may be pointed a given satellite at a given time.

### BACKGROUND

Geosynchronous orbits are advantageous to operators of commercial and governmental satellite communications systems in large part because a satellite in geosynchronous orbit enjoys a period of revolution around the earth that is exactly equal to one sidereal day, the time required for exactly one rotation of the earth under the satellite, resulting in a satellite that appears stationary above the same point on the earth. Thus, geosynchronous orbits are termed parking orbits. Such parking orbits are established by the laws of physics, including Kepler's law of equal area subtended in equal time. Such Kepler geosynchronous orbits are so valuable economically that the United Nations and other treaty organizations mediate the allocation of such parking orbits, i.e. to countries of the UN. The laws of physics including Kepler's law appear to limit the number of satellites in what may be termed Kepler geosynchronous parking orbits to those orbits presently known and allocated, i.e. by treaty. As the number of satellites increase, the reduced distance between adjacent satellites becomes problematic. For example, since radio frequency (RF) antennas on the ground are imperfect, main beams and sidelobes of uplinks may interfere with adjacent parking orbits.

Kepler geosynchronous satellites are widely known to be vulnerable to jamming from the ground by a malicious agent focusing many megawatts of RF energy on such a discrete satellite in such a specific parking orbit known via treaty to be the property of a given nation, e.g. causing denial of service. Satellites in such Kepler parking orbits also may be vulnerable to physical destruction, e.g. via anti-satellite satellites. Hence, Kepler geosynchronous satellites offer a single point of vulnerability for electromagnetic disruption and physical denial of service.

### SUMMARY OF THE INVENTION

This Summary is provided to introduce a selection of concepts in a simplified form that are further described below in the Detailed Description. This Summary is not intended to identify key or essential features of the invention.

A conical region in space with a base at a geosynchronous distance from the earth and an apex of the cone at a point on the ground may be termed a space needle. According to various embodiments, a multiplicity of small satellites in elliptical orbits located at a given instant in time within a space needle may establish precise timing of their RF transmissions to form what may be termed a needle beam. The needle beam is an RF downlink transmission having an apparent single origin that may be thousands of kilometers above or below (to the North or South) of a Kepler geosynchronous satellite parking orbit. For reception at a specific point on the ground, the origin of the needle beam signal may appear to be fixed with respect to an observer on earth because of a continuous adjustment of mutual reinforcement of RF signals transmitted from the multiplicity of small satellites. In some embodiments, an adjustment may compensate for frequency shift induced by motion, e.g., Doppler frequency shift by pre-distorting such a signal so that the signal's received form has no Doppler shift. A phase center of the RF needle beam transmission may appear to have signal in excess of noise to an observer within a very small distance from an intended point on the ground, which may be termed a needle beam footprint. Observers on the ground outside the needle beam footprint may not observe the RF signal from the needle beam satellites in excess of noise.

In some variations, a noise-like RF signal may be transmitted synchronously from multiple satellites in space forming a spatially distributed spread spectrum RF signal. A multiplicity of satellites spread out over a space needle may offer improved communications, resilience to jamming, and resilience to physical destruction of one or more such satellites.

In other embodiments, applying the method of space-based needle beam formation to a multiplicity of transmitters on the ground, a network of ground stations may form a ground-based needle beam uplink that may be pointed at a given satellite at a given time. Continuous alteration of RF transmission from the ground may result in continuous reception of the signal above noise at the intended satellite. Variations may include transmitting a noise-like RF signal synchronously from multiple transmitters on the ground forming a spatially distributed spread spectrum RF signal. Such a noise-like signal transmitted on an uplink needle beam and received by one or more satellites in Kepler geosynchronous parking orbits may exhibit less energy than thermal noise, thus not causing harmful RF interference.

Ground based and space-based needle beams may synchronize their transmissions via a pseudo-random arrangement. Such downlink and uplink needle beams may be resistant to jamming. Space-based needles may continue to provide communications services in spite of the physical malfunction or destruction of one or more of the satellites in the space needle forming the needle beam. Ground-based needles may continue to provide uplink services in spite of the physical malfunction or destruction of one or more ground based transmitters of a ground constellation.

### BRIEF DESCRIPTION OF THE DRAWINGS

Some embodiments are illustrated by way of example, and not by way of limitation, in the figures in which like reference numerals refer to similar elements.

FIG. 1 illustrates a Kepler geosynchronous orbit with illustrative parking slots;

FIGS. 2A and 2B illustrate a space needle in accordance with one or more embodiments;

FIG. 3 illustrates a footprint of a needle beam in accordance with one or more embodiments;

FIG. 4 illustrates a transmitter in accordance with one or more embodiments.

FIG. 5 illustrates a receiver in accordance with one or more embodiments.

FIGS. 6A and 6B illustrates processes according to one or more embodiments.

FIG. 7 illustrates an uplink needle beam in accordance with one or more embodiments.

### DETAILED SPECIFICATION

FIG. 1 illustrates the current state of orbits and allocations by treaty of parking orbits for geosynchronous communications satellites. A particular circular orbit of the earth 110 has a period of exactly one sidereal day, resulting in a position of a specific satellite at a specific point 120 above the earth being stationary over a specific point on the earth surface. International organizations have established boundaries between adjacent parking orbits, as illustrated at points 130 and 131, in order to reduce signal interference from the satellites in adjacent parking orbits. A line 140 illustrates the geometric relationship between a satellite in a parking orbit and a corresponding point beneath that satellite that may lie on the earth's equator.

FIGS. 2A-2B illustrate one example of a space needle system 200. FIG. 2a illustrates the space needle system 200 with respect to a geosynchronous satellite orbit 110 and line 140 shown for comparison. As illustrated in the detailed view in FIG. 2B, space needle 200 may include a cone with a base radius 220 and axis 230. The space needle cone may have an apex 250 at a specific point on the earth along the axis 230. While apex 250 is illustrated in FIGS. 2A and 2B near the equator, apex 250 may be located at any point (e.g., any latitude, longitude, and altitude) on the earth surface. While the shape of a space needle 200 is illustrated as a cone in FIGS. 2A-2B, a space needle may have a square base, e.g. of width 220 and height 220, forming a pyramid, or of another shape that may establish a volume occupied by such a needle. Throughout this disclosure, the term “cone” shall not limit the shape of such a space needle to the illustrative conical shape of FIG. 2A-2B but may refer to any specified shape. Apex 250 may also be above or below the earth's surface. Axis 230 may further have any elevation angle 240 (e.g., north or south) with respect to line 140 and any cross-angle (e.g., east or west) (not shown) with respect to line 140. The cone of space needle 200 may subtend a volume occupied by satellites forming an RF space needle beam at a given point in time. Satellites within the cone of space needle 200 may share information via cross-links (e.g., optical or RF transmissions) between the satellites. The locus of the space needle cone defined by 220, 230, and 250 may not change over time, but the collection of satellites 210, 211, 212, etc., forming the space needle beam at a given point in time may change as satellites enter and leave the cone of space needle 200. That is, as the satellite leaves the cone, it may cease its transmission contributing to the space needle beam, and when a satellite enters the cone it may begin transmission contributing to the space needle beam.

A space needle system 200 may include a collection of satellites, e.g., 210, 211, and 212, mutually supporting uplink and/or downlink RF transmissions within the space needle cone. Satellites 210 and 211, for example, may orbit the earth with a multiplicity of other satellites sequentially in a given nearly circular, nearly geosynchronous elliptical orbit. Another satellite 212, for example, may occupy an alternate nearly circular, nearly geosynchronous elliptical orbit along with a multiplicity of other satellites in an orbit of the same or nearly identical orbital parameters. A multiplicity of additional satellites of the space needle system 200 may occupy a multiplicity of other nearly circular, nearly geosynchronous elliptical orbits such that satellites 210, 211, 212, and other such satellites within the system may occupy a space needle cone at the same time. A multiplicity of small satellites spread out over the space needle cone may improve the communications link signal to noise ratio, improve resilience to jamming, and improve resilience to physical destruction of one or more of a multiplicity of such satellites. While various examples are presented herein with respect to satellites in nearly geosynchronous orbits, the other satellite orbits (e.g., polar, HEO, MEO, etc) may also be used to form a space needle.

As one non-limiting example, there may be a space needle SN1 having an elevation of 385,300 meters above (to the North of) geosynchronous orbit with respect to a reference point on the earth of longitude zero, and for convenience of explanation of latitude zero. Space needle SN1 may establish a base radius R-SN1 of e.g. 200,000 meters at geostationary altitude of 35,790,000 meters. Such an altitude may comprise a distance between a satellite and a ground station. Satellite orbits within the space needle cone would have a maximum elevation of (i.e., at the edge of the base closest to the north pole) of approximately 585,300 meters and a minimum elevation of 185,300 meters (i.e., at the edge of the base closest to the equator). In addition, satellites contributing radio signals to the space needle beam may exhibit cross-angle (e.g., east-west) distance of plus or minus 200,000 meters from the center of such a space needle (i.e. distance from the axis 230) as spacecraft 210 enter, transit 211, and depart 212 such a space needle, e.g. SN1.

FIG. 3 further illustrates the method and apparatus of a space needle as a multiplicity of arrangements between satellites 210 and 211; between satellites 211 and 212; between satellites 210 and 212, and among a multiplicity of any other pair of satellites forming a space needle at a given point in time by considering in greater detail one such pair of satellites 310 and 330.

A footprint is an extent on the surface of the earth (or above or below the surface of the earth) within which a radio signal may be received, e.g. at a specified ratio between signal and noise (SNR). A satellite 310 within a cone of a space needle may point an RF antenna towards the earth that may have a beam that forms a footprint 320. Another satellite 330 may point an RF antenna towards the earth that may have a second beam that forms a second footprint 360 that may overlap substantially with first footprint 320.

A footprint of an RF transmitter depends on the transmitted carrier frequency, fc, and on the physical extent of a transmitting antenna (i.e. the aperture). The beamwidth of a transmitting antenna is inversely proportional to the aperture of the antenna, e.g. measured in meters or in a number of wavelengths. The footprint is directly proportional to the tangent of the beamwidth times the distance between antenna and receiver, and specifically in the case of satellite 310, the distance between the satellite and the earth. More wave lengths per aperture yields a proportionally narrower beam. For example, a 3-meter diameter parabolic satellite antenna may have a diameter of four wavelengths at fc of 400 MHz, of sixteen wavelengths at fc of 1.6 GHz, and 25 wavelengths at fc of 2.5 GHz. The corresponding beamwidths may be 90 degrees, 22 degrees, and 14 degrees respectively, according to the inverse proportion of a sphere and according to known methods of determining the width of a beam, such as from points half the signal strength of the maximum at the boresight of the beam (i.e. −3 dB). As another example, the beamwidths of a 20 meter parabolic antenna may be 13.46, 3.46, and 2.15 degrees respectively according to an inverse proportion relationship for the same carrier frequencies.

The diameter of an RF footprint 320 and 360 may be twice the product of distance times the tangent of half of the beamwidth. For example, a 20 meter aperture antenna transmitting from a geosynchronous satellite parked 35,790,000 meters from earth would generate a footprint that is 8.56 million meters in diameter for a carrier frequency fc of 400 MHz, 2 million meters in diameter for a fc of 1.6 GHz, and 1.35 million meters for an fc of 2.5 GHz. Footprints at Ku (12.5 GHz) and Ka (19.7 GHz) bands (e.g., for television broadcasts) transmitted with a 2-4 degree beamwidth would have footprints of spot beams, e.g., having a diameter of approximately 1287 kilometers (800 miles). Such antenna apertures may have a narrower beamwidth by using larger reflectors with feed horns, millimeter wave space fed arrays, phased arrays, or another antenna that may be pointed mechanically or steered electronically to a fixed point on the earth. In various embodiments, space needle satellites 310 and 330 may together form an antenna array to generate a synthetic antenna aperture that is many orders of magnitude larger than is possible by one or more antennas mounted to a single satellite alone.

Satellites 310 and 330 may employ signal processing according to which signals may be received on the ground at a signal strength that may be less than ambient thermal noise, such as Boltzman's constant times temperature times bandwidth (i.e. kTB). Received signal strength may be greater than kTB, but may have a noise-like appearance and statistics in time and frequency according to a specific space needle apparatus, e.g. according to data rates, transmitting antenna properties, receiving antenna properties, transmitting signal processing, reception signal processing, and minimization of interference with a multiplicity of other users of the frequency spectrum. Such a signal may be distributed over the surface of the earth according to the RF footprint of each spacecraft 310 and 330.

Satellites 310 and 330 may be, for example, any one of a multiplicity of satellites in an orbit of a satellite 210, an additional multiplicity of satellites in an orbit of satellite 211, an additional multiplicity of satellites in an orbit of satellite 212, and/or an additional multiplicity of satellites in an orbit crossing the space needle cone. These satellites may arrange to align the centers of their RF footprints at a common fixed point 340 on the earth. An arrangement of signal modulation, timing, and signal processing of RF signals between satellite 310 and satellite 330 may provide for RF waves from each satellite to be mutually reinforcing with one another within the signal processing of a receiver located at a point 340 on the earth corresponding to the tip of a needle beam 350.

The distance, d, between satellites 310 and 330 may determine the width of needle beam 350 according to a method of radio astronomy termed aperture synthesis. According to aperture synthesis, the spatial resolution of a pair of radio transmitters separated by a distance, d, is proportional to a unit circle (i.e., 360 degrees) divided by d (e.g., 360/d). A space needle system consisting of a multiplicity of satellites and a corresponding receiver may realize aperture synthesis of space needles via cross-links between pairs of such satellites, such as laser or millimeter-wave data links.

Such an arrangement between a satellite 310 having a footprint 320 and a satellite 330 having a footprint 360 substantially overlapping footprint 320 by pointing at a common point on the ground 340 may result in a very narrow beam 350 of mutual reinforcement having a beamwidth proportional to 1/d and a synthesized point of origin 370 along a line between the two satellites (e.g., half way between the two satellites. The synthesized origin, depending on phase adjustments, may lie anywhere on the line between the two satellites. More generally, for three or more satellites, the synthesized origin may lie anywhere in a volume bounded by the satellites, with carrier signal phases continuously adjusted to maintain a constant origin position. In some embodiments, an adjustment may compensate for frequency shift induced by motion, e.g., Doppler frequency shift, by pre-distorting such a signal so that the signal's received form has no Doppler shift.

For example, the radius 220 of the cone base in FIG. 2 may be 200,000 meters at a geostationary orbit altitude of 35,790,000 meters from the earth surface, which results in a volume in which three dimensional distances between satellites may be 500,000 m. For, example, a distance, d, of FIG. 3, between a satellite 310 and a satellite 330 may be 447 kilometers. At a 400 MHz signal frequency, for example, such a distance may correspond to 598,000 wavelengths between the satellites. A resulting beamwidth from aperture synthesis may be proportional to a unit circle (360 degrees) divided by 598,000 wavelengths, or 602 micro-degrees and to a needle footprint of 376 meters in diameter for satellites in an elliptical orbit near geosynchronous altitude of 35,790,000 meters. A given pair of satellites 310 and 330 may form one central most powerful reinforcing needle beam footprint with many smaller less powerful narrow beams of sidelobes pointing generally in similar directions, but at points on the ground other than at a central point 340. The needle beam footprint (needleprint) formed by the pair of satellites 310 and 330 with synchronized transmissions having an RF carrier fc of 1525 MHz, for example, may exhibit a needleprint 93 meters in diameter on the earth. The same satellites with an RF carrier fc of 2655 MHz may exhibit a needleprint of 60.19 m. The same satellites with an RF carrier fc of 14000 MHz may exhibit a needleprint of 12.28 m. The same satellites with an RF carrier fc of 19500 MHz may exhibit a needleprint of 7.6 meters. A multiplicity of space needle satellites may be synchronized for a specific point on the ground to exhibit a central needle beam with received signal strength proportional to the number of cooperating satellites. Such a multiplicity of satellites may not reinforce smaller narrow sidelobes, resulting in only one fully reinforced central downlink needle beam formed by a multiplicity of satellites within overlapping footprints of satellites of a given needle beam.

In some variations, a receiver on the earth may combine signals from multiple satellites according to a process of multiple-input multiple-output (MIMO) channel combining. For example, in some embodiments an apparatus could receive the signals from the multiplicity of satellites using a multiplicity of receiver antenna elements (each element receiving the signal from all of the satellites) and record the received energy in a multiple input multiple output memory (e.g., digital recording) over a period of time. From the recorded data, the measured energy received on each antenna element may be adaptively combined according to space-time adaptive processing (STAP), to form a synthetic reception beam pointed in the direction of the needle beam 350.

FIG. 4 provides an example transmitter of one of the space needle satellites (e.g., satellite 310 of FIG. 3) for the signal forming a footprint 320 resulting in a needleprint 340. FIG. 6A illustrates a process that may be performed by the transmitter 400 illustrated in FIG. 4. A satellite 310 in a cone of a needle beam may synthesize a needle beam downlink via communications and synchronized RF transmissions with other satellites in a given cone via electronic circuits 400. The other satellites may have the same functionally similar transmitter as shown in FIG. 4. In step 681, sensors 410 may receive signals 401 from external phenomena that may include light from stars. A location estimator circuit 440 may receive information 411 regarding the intensity and position of light in a star field to produce an estimate of the location of the satellite with respect to a multiplicity of stellar constellations. Sensors 410 may also receive signals 402 from solar panels corresponding to the intensity and direction of solar radiation with respect to the satellite. In step 682, the location estimator circuit 440 may further receive and/or generate ephemeris data for satellite 310 that may specify a location of the satellite as a function of sensor data (such as of a star field and a GPS satellite system) with respect to known fixed features of the earth such as the North Pole and the equator. The ephemeris data may include specific times indicating when the satellite was at the locations indicated in the ephemeris data.

In step 683, the location estimator circuit 440 may generate a location estimate 441, and in step 684 precision clock circuit 420 may generate a reference time 421. In step 685, the trajectory estimator circuit 450 may receive the reference time 421 from a precision clock circuit 420, along with the location estimate 441 and sensor data 412, e.g. regarding sun angle, therewith computing a refined estimate of location, velocity, acceleration, and jerk (rate of change of acceleration), termed an ephemeris vector 451, as a function of time. In step 686, a crosslink 430 may receive a signal from one or more other satellites within the cone of the needle via one or more cross-link signals 431 (e.g., laser, microwave, etc.).

In step 687, the crosslink 430 receiver may count cycles of signal 431 according to which it may provide a correction 432 to a precision clock 420. The cycles of the crosslink signal 431 may be synchronized to a similar precision clock in the satellite sending the crosslink signal. In step 688, the trajectory estimator circuit 450 may receive an accounting of cycles of the crosslink signal 431 from the crosslink receiver 430 according to which it may refine its estimates of satellite ephemeris vector 451. In some embodiments, a progression of steps 681, 682, and 683 may generate a single estimate of satellite location, the time of which may be associated in step 684. A subsequent progression 681, 682, and 683 may generate a second estimate of satellite location a second time of which may be associated in a repetition of step 684 forming a vector of difference between a first estimate and a second estimate. A sequence of such repetitions of location estimate with associated time may yield a line in three-dimensional space defined by a series of such vectors, the parameters of which are termed ephemeris. In step 685, a plurality of measurement vectors may be compared to an ephemeris representative of an idealized orbit of the satellite forming the ephemeris vector, a four dimensional difference vector having three dimensions of space plus time. Such a vector may express satellite location at a given time with an error of hundreds or thousands of meters. A sequence of such vectors of step 685 include second and third differences estimating acceleration and jerk. A multiplicity of satellites of a needle beam may form such estimates of the satellite's own position, velocity, acceleration and jerk with respect to its own expected ephemeris. A satellite may employ such position, velocity, acceleration and jerk estimates to point a laser cross-link at another satellite. Each satellite may point a multiplicity of such laser cross-links that may result in the receipt of timing information at step 686. Laser cross-link timing may be coded according to a precision clock 420 that may result in a difference between a reference clock and a laser cross-link that may be used to adjust such a precision clock at 687. A distance between two satellites connected via a laser cross link may be computed by exchange of data in the trajectory estimator 450 that may refine ephemeris vectors according to a comparison of timing of a cross-link 430 according to a timing signal 432. Step 688 may combine sensor-based location, velocity, acceleration and jerk vectors, ephemeris of a satellite and a laser-connected satellite, and precision time references to refine the accuracy of such vectors according to the precision of the wave length of a laser cross-link that may be a distance of less than 2000 nanometers with such error covariances as may characterize the stability of laser cross-link electronics. Accordingly, a progression of steps 681-688 may refine estimates of such vectors many thousands or millions of times per second, continuously refining such estimates according to the square root of the number of such refinements, e.g. having a value of less than 1/250^{th} of a radio frequency wave length according to a signal 451 derived from steps 681-688, such as may be appropriate to precisely establishing timing and phase of a radio frequency transmission.

In step 689, the digital RF synthesizer 460 may combine an estimated ephemeris vector 451 with information 433 from the crosslink receiver 430 to define an RF phase of an RF carrier signal. Such a phase may be, for example, an integer number of wavelengths between the satellite at a position at a time T-send and a center of a needle beam on the surface of the earth along with a fraction of a wavelength according to which at a time T-Send may result in a full wave signal received at a receiver at the center of a needleprint, CNP.

For example, a spacecraft number 1, SC1 having a 400 MHz transmission frequency may compute a distance to CNP of 56,365,363.47 wavelengths which metric may have such an accuracy according to the accuracy of a precision timing and frequency standards on each such spacecraft and according to the use of high precision arithmetic, such as 64 bit floating point arithmetic. A second spacecraft SC2 may compute a distance of 56,366,340.73 wavelengths to CNP, distances differing by 977.26 wavelengths. Accordingly, a spacecraft SC1 may initiate a transmission 977.26 wavelengths prior to a second spacecraft SC2 so that their signals may begin to arrive at the intended receiver at the same time. A cycle of a 400 MHz wavelength may have a period of 2.5 nanoseconds. A precision clock 420 may have an accuracy of 0.01 nanoseconds (i.e. 10 picoseconds), providing 250 tic marks per sine wave of fc. Accordingly, a time according to which to initiate a delay of 977.26 wavelengths may be determined by trajectory estimator 450, sending a control signal to initiate synthesis at an appropriate time delay. Such phase estimates may be further adjusted according to a reference point such as a point at the center of the base of such a space needle that may be the apparent point of origin of mutually reinforcing signals. In some embodiments an adjustment may compensate for frequency shift induced by motion (e.g., Doppler frequency shift) by pre-distorting such a signal so that the signal's received form has no Doppler shift.

In step 690, the digital RF synthesizer 460 may impart a pseudo-noise (PN) sequence onto an RF carrier according to an RF carrier phase and a pseudo-noise sequence. The PN sequence may be used to spread a data sequence 491 (e.g., payload data) for transmission from the satellite. A spectrum allocation, e.g. of 10 MHz, may limit the bandwidth of such a pseudo-noise modulation, e.g. to 10 MHz. A chip rate for a direct sequence spread spectrum pseudo-noise (PN) reference signal may be 10 million chips per second. Each chip may have a period of 100 nanoseconds that may correspond to 40 periods of a carrier frequency. Such a digital RF synthesizer 460 may digitally synthesize one sample of a sine wave every 10 picoseconds with a wave having a positive cycle representing a binary 1 of a PN code and having a negative cycle representing a binary 0 of a PN code.

In step 691, weighting estimator 470 may compute weighting coefficients according to a location estimate 441. The weighting estimator may adjust the weight coefficients of an entire beam of a given spacecraft with respect to the weight coefficients of a beam of another spacecraft known via the laser cross link so that one transmission as a whole may be stronger or weaker than another. More specifically, a signal from a satellite at a greater distance from an intended point on or near the earth may have a greater loss in transmission than a signal from a closer satellite. Therefore in one embodiment, a more distant satellite may have a weight that may be proportionally greater than a more proximate satellite, e.g. so that the received power from both satellites is approximately the same. Similar proportions may be applied to elements of antenna feeds to adjust signal strength for a more uniform pattern at or near the ground. The precision of a trajectory estimate may not be required for estimating such weights of signal strength per antenna element. In step 692, the transmitting (TX) antenna array 480 may impart a modulated RF carrier signal 461 to elements of an antenna array according to signal strengths and phases for each element indicated by of weights 471, which are calculated by weighting estimator to steer the RF transmission 481 in the direction of the CNP.

The phase of an RF carrier, PN modulation and antenna weighting may change according to a time scale of a precision clock 420 distributed to digital RF synthesizer 460, weighting estimator 470 and antenna array 480. The timing of such signals at a given satellite may correspond to an estimated time of arrival based on the speed of light and number of wavelengths of distance, arriving at a point on the earth corresponding to a CNP of the cone of a space needle according to the methods described with respect to FIGS. 2 and 3. The timing of such signals may cause the apparent point of origin of a composite signal received from multiple satellites within a cone of a space needle to appear to originate at a fixed point in space, from a fixed point above, below, or within a Kepler geosynchronous orbit.

A multiplicity of satellites within a cone of a space needle may transmit the same information content for reception by a smaller or simpler antenna and receiver on the ground. For example, a third satellite may compute a distance of 56,367,317.99 wavelengths to CNP. In a preferred embodiment, a multiplicity of satellites within a cone of a space needle may transmit identical information content having PN codes suited for reinforcement at CNP.

Signal processing parameters of weighting 471, trajectory 451, cross link 443, digital RF 461, and antenna array 480 of a multiplicity of satellites of a cone of a space needle may focus an RF signal of a central needle beam forming a footprint of a needle beam at a specific point on the ground that may coincide with a location of a ground based receiver. Multiple ground-based receivers on the ground may be networked. Spacecraft within the cone of a space needle may coordinate downlink information-content and signal processing parameters via cross-links. Rapid coordinated alteration of signal processing parameters forming a footprint may result in the rapid movement of the apex of the cone resulting in the movement of a footprint of a needle beam from one intended ground based receiver to another, increasing the communications security of such a needle beam downlink.

FIG. 5 illustrates the circuits and operation of a ground based space needle receiver 500 for a signal transmitted, in a first instance, from satellites of a space needle. Sensors 510 may acquire signals 501 such as from a Global Positioning Satellite (GPS) constellation. A location estimator circuit 540 may employ parameters 511 from the sensors 510 to estimate a location of a ground based receiver. Such a receiver may be located at a fixed site on the ground. Such a receiver may be located on a ship, submarine, or other vessel. Such a receiver may be located on an aircraft or other spacecraft, such as in a low earth orbiting (LEO) satellite. For simplicity of explanation, a fixed receiver on the ground is presented as an illustrative example.

A trajectory estimator 550 may estimate the relative trajectory between receiver 500 and a satellite of a cone of a space needle via sensor data 512, self-location estimates 541 and timing signals 531 from a precision clock 530. A weighting estimator 570 may compute weights 571 according to a location estimate of a self-location 541 pointing at an intended satellite receiver.

A receiving (RX) antenna array (not shown) may combine incoming RF signals 521 according to weights 571 to provide a weighted RF signal 522 to a digital receiver 560. A digital receiver 560 may adaptively correlate, equalize and adjust weighted signals 522 according to a pseudo-noise sequence generated according to an estimate of satellite trajectory 551. Such a digital receiver may adjust weights, correlation of pseudo-noise sequence, and other signal processing parameters according to a precision clock 530. Such a digital receiver may correlate, track, demodulate, decode, error correct, and otherwise extract useful information 561 from signals 522 according to parameters 551.

In an alternate arrangement of signal processing parameters of its constituent circuits, a receiver of FIG. 5 may be employed in a fixed ground-based facility. Parameters such as radio frequency, bandwidth, spreading codes and processing time window may be chosen according to the ground-station's fixed position. In an alternate arrangement of signal processing parameters, a receiver of FIG. 5 may be employed in a vehicular ground based configuration having a radio frequency, bandwidth, spreading codes, and processing time window according to the expected vehicle motion, accuracy of vehicle location, and accuracy of vehicle motion estimates. Similarly, there may be alternate signal processing parameters for ship-based, airborne, space-based or other receivers or in a combination of such receivers.

FIG. 6B illustrates a process that may be performed by digital receiver 560 of FIG. 5. A signal 601 may enter the receiver 560 as digital samples 610 from each of a multiplicity of antenna elements in array 520, each element having been sampled at a very high rate, e.g. oversampled with respect to the bandwidth of the space needle signal. There may be a buffer containing many seconds of signal samples 610. A pseudo-noise (PN) source 615 may provide a reference signal to a correlator 620 to cross-correlate PN 615 with samples 610. Cross-correlator 620 may produce a cross-correlation having a correlation peak P with respect to an antenna element j at time t1, peak Pj(t1). There may be as many peaks as there are antenna elements. According to space-time adaptive signal processing, correlation peaks may be realized with respect to signal subspaces that may be determined by matrix inverse and matrix multiplication by cross-correlator 620.

An examination of peaks Pj may occur to select a next-peak 630. An initial peak P1(t1) may be selected. A second peak P2(t2) may have a peak time t2>t1. Peak alignment 640 may determine that t2>t1, determining a delay dt=t2−t1 by which a delay controller 650 may adjust signal processing parameters of sampled signals 610 and correlator 620 to align the peaks. Upon alignment of peak P2, a test 640 may be made to determine whether all peaks are aligned. If not then a next peak selector 630 may select a next peak P3(t3) where t3>t1. At some point, all peaks will be aligned. The precision of peak-alignment will be according to the precision of over sampling. A precision clock having, for example, 10 picoseconds per tic and an oversampling of 100 GHz may result in a precision of 10 picoseconds of alignment, which may be 1/250 of a wavelength, e.g. at 400 MHz. A space-time adaptive processing (STAP) integrator 670 may further align signals from multiple antenna elements with respect to signal subspaces so that multiple signals received are mutually aligned for mutual reinforcement according to the precision of a receiving clock 530. Such a fine-alignment process may compensate for errors in distance estimates between each satellite and the CNP.

FIG. 7 illustrates an arrangement for the formation of uplink needle beams according to the generation of space needles presented with respect to FIGS. 2-5. In FIG. 7, a sub-satellite line 140 between a Kepler geosynchronous satellite and the equator is included for clarity of disclosure. A ground station 730 may be one of a multiplicity of ground stations including ground station 731, etc. Such a ground station may employ terrestrial communications such as the Internet as cross-links among ground stations. A location estimate of a transmitting antenna of such a ground station may be known very accurately (e.g. to within centimeters). An interconnected collection of such ground stations may form a ground constellation. A multiplicity of ships, submarines, aircraft, and/or LEO satellites having accurate estimates of their own positions with respect to a reference point and with suitable cross-links may form such a ground constellation. A ground constellation may form the base of an uplink cone with a base near the earth's surface and a point of mutual reinforcement that may be a spacecraft 720 receiving an uplink needle beam.

A ground station 730 may illuminate a volume 710 of a cone of a needle beam such that RF energy 740 may impinge on any satellites 720, 721, etc. that may be within such a cone at a given point in time. Another ground station 731 may illuminate a volume 710 of such a cone via an RF beam 741. Signals from a ground station transmitter 730 of a ground constellation may be generated by a transmitter (e.g., FIG. 4) of an apparatus having sensors 410, a precision clock 420, a cross-link 430, a location estimator 440, a trajectory estimator 450, a digital RF synthesizer 460, a weighting estimator 470, and a transmitting antenna array 480 of a transmitter 400.

Signals originating from a transmitter 400 at a ground station 730 and from a second transmitter 400 at a second ground station 731 may be synchronized via precision clocks and via ground based cross-links so that RF signals of broad RF beams 740 and 741 may be mutually reinforcing forming an uplink needle beam for reception by a given satellite 720. RF transmission parameters of such transmitters may be changed at each successive point in time of a precision clock 420, moving the focus of an uplink needle beam to continuously point at a destination satellite that may be in motion with respect to ground stations. Other pairs of ground station transmitters may be similarly synchronized to mutually reinforce at a given satellite 720 that may be in motion. The signal processing parameters of such a transmitter may be adjusted to incorporate location on the ground of a fixed constellation with respect to a moving satellite as a point of an uplink needle beam, directing energy and synchronizing energy to be mutually reinforcing, so as to be received with positive signal to noise ratio after signal processing by a given satellite 720 at the apex of the cone.

In an alternative preferred embodiment, a ground constellation may consist of slowly moving vehicles such as ships or ground vehicles linked via crosslinks (e.g., microwave, optical, RF, GPS, etc.) as may be available to such pairs or to networks of such vehicles. In an alternative preferred embodiment, a ground constellation may consist of aircraft or LEO spacecraft linked via such crosslinks as may be available to pairs or to networks of such craft.

A ground constellation may coordinate its transmission parameters to direct a needle beam uplink to an intended satellite 720, and then move the needle footprint to some other satellite 721 or to some other satellite. Rapid switching by the transmitters of a ground constellation from one intended recipient satellite to another may increase the security of communications between the ground and the satellites of a cone of a space needle.

An arrangement of a space needle as a cone in space that may be fixed with respect to an observer on the earth and a multiplicity of satellites along with a multiplicity of ground based receivers and transmitters of a ground constellation may comprise a space needle communications network. The space needle network may relay communications originating at a point on the ground through satellites of a space needle to another point on the ground within the network. Alternatively, the space needle network may transfer information that may originate in space to one or more ground stations, such as remote sensing data or such as instrumentation, configuration, operations, and maintenance data of satellites.

A multiplicity of satellites of a cone of a space needle 710 including for example, satellites 720 and 721 may receive signals from one or more ground-based transmitters according to a receiver 500 of FIG. 5. Satellites of such a space needle 710 may share information via cross-links, e.g. for diagnostic, operations, and maintenance purposes. Shared information may include raw signal data, preprocessed signal data, correlated signal data, soft decoded bits of a digital communication, quantized samples of an analog communication, forward error control, and turbo-coding among others. Parameters of such receivers and cross-links may be set to facilitate (1) reception of needle beam uplink transmissions or (2) reception of conventional uplink transmissions or (3) to enhance conventional uplink transmissions via integration of information of satellites 720, 721 and others via a digital receivers 560 of a multiplicity of such spacecraft, or (4) mixing parameters (1)-(3) as may be suitable or convenient for space needle operations.

A ground constellation may transmit uplink signals to spacecraft of multiple alternate space needles near-simultaneously for example via alternative frequencies, or via time-sharing. A given satellite may transmit downlink signals for multiple alternate space needles near-simultaneously, for example via alternative frequencies, or via time-sharing. In such an arrangement, multiple space needles may relay information around the world via multiple hops from space to ground. Alternatively, space-based cross-links 430 may enable relay around the world via satellite-to-satellite relay across space needles without the use of an intermediate ground relay.

Various aspects of FIGS. 4-6 (e.g., 410, 430, 440, 450, 460, 470, 480, 510, 520, 540, 550, 560, 570, 610, 615, 620, 630, 640, 650, 660, and 670) and other operations described herein may be implemented with a computer platform that includes one or more processors. The processors may be implemented with any of numerous types of devices, including but not limited to one or more microprocessors, microcontrollers, digital signal processors, embedded processors, application specific integrated circuits, field programmable gate arrays, and combinations thereof. In at least some embodiments, at least one of the processors may carry out the operations described herein according to machine-readable instructions (e.g., software) stored in one or more memories that may also be included in the computer platform. The memory may include volatile and non-volatile memory and can include any of various types of storage technology, including but not limited to read only memory (ROM) modules, random access memory (RAM) modules, magnetic tape, magnetic discs (e.g., a fixed hard disk drive or a removable floppy disk), optical disk (e.g., a CD-ROM disc, a CD-RW disc, a DVD disc), flash memory, and EEPROM memory, or other devices with equivalent capabilities. Other hardware may also be included in the platform, such as analog-to-digital converters for receiving sensor data, RF and optical interfaces for sending and receiving cross-link data, data buses for interconnecting the various component, etc.

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. For example, one of ordinary skill in the art will appreciate that some steps described with respect to the figures may be performed in other than the recited order, and that one or more steps illustrated may be omitted in one or more embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention.

I claim:

1. A method comprising:
receiving via a communication link, ephemeris data indicating a first distance between where a first satellite will be located at a future time and a location on earth;
calculating a second distance between where a second satellite will be located at the future time and the location on earth;
receiving timing information indicating a first phase and first frequency shift relative to the future time of a first carrier signal to be transmitted from the first satellite to the location on earth; and
determining, based on the first and second distances and the timing information, a second phase and second frequency shift relative to the future time of a second carrier signal to be transmitted from the second satellite, wherein if the first and second carrier signals are transmitted with the first phase and the second phase, the signals will mutually reinforce at the location on earth.

2. The method of claim 1, further comprising:
transmitting the second carrier signal at the second phase relative to the future time.

3. The method of claim 2, further comprising:
adjusting the second phase of the second carrier signal being transmitted over a duration such that the first and second carrier signals mutually reinforce at the location on earth over the duration.

4. The method of claim 3, wherein the first and second satellites, over the duration, maintain a position within a spatial cone having an apex at the location on earth and a base in space, wherein the radius of the base determines a size of a footprint about the location on earth outside of which the first and second carrier signals do not mutually reinforce.

5. The method of claim 4, further comprising:
transmitting from a third satellite entering the spatial cone a third carrier signal to the location on earth, the third carrier signal having a third phase adjusted such that the second and third carrier signals mutually reinforce within the footprint over a second duration.

6. The method of claim 5, further comprising:
ceasing transmission of the first carrier signal from the first satellite when the first satellite passes out of the cone.

7. The method of claim 1, wherein the first and second satellites are in near geosynchronous elliptical orbits having inclinations greater than zero.

8. The method of claim 1, further comprising modulating a pseudo-random noise sequence onto the second carrier signal.

9. The method of claim 1, wherein the first and second satellites are in polar orbits.

10. An apparatus comprising:
one or more processors; and
one or more memories storing computer executable instructions that when executed by the processor, cause the apparatus to
receive via a communication link, ephemeris data indicating a first distance between where a first satellite will be located at a future time and a location on earth;
calculate a second distance between where a second satellite will be located at the future time and the location on earth;
receive timing information indicating a first phase relative to the future time of a first carrier signal to be transmitted from the first satellite to the location on earth; and
determine, based on the first and second distances and the timing information, a second phase relative to the future time of a second carrier signal to be transmitted from the second satellite, wherein if the first and second carrier signals are transmitted with the first phase and the second phase, the signals will mutually reinforce at the location on earth.

11. The apparatus of claim 10, wherein the computer executable instructions, when executed by the one or more processors, further cause the apparatus to:
transmit the second carrier signal at the second phase relative to the future time.

12. The apparatus of claim 11, wherein the computer executable instructions, when executed by the one or more processors, further cause the apparatus to:
adjust the second phase of the second carrier signal being transmitted over a duration such that the first and second carrier signals mutually reinforce at the location on earth over the duration.

13. The apparatus of claim 12, wherein the first and second satellites, over the duration, maintain a position within a spatial cone having an apex at the location on earth and a base in space, wherein the size of the base determines a size of a footprint about the location on earth outside of which the first and second carrier signals do not mutually reinforce.

14. The apparatus of claim 10, wherein the computer executable instructions, when executed by the one or more processors, further cause the apparatus to:
cease transmission of the second carrier signal from the second satellite when the second satellite passes out of the cone.

15. The apparatus of claim 10, wherein the first and second satellites are in near geosynchronous elliptical orbits having inclinations greater than zero.

16. The apparatus of claim 10, wherein the computer executable instructions, when executed by the one or more processors, further cause the apparatus to:
modulate a pseudo-random noise sequence onto the second carrier signal.

17. The apparatus of claim 10, wherein the first and second satellites are in polar orbits.

18. The apparatus of claim 10, wherein the apparatus is comprised within the second satellite.

19. A system comprising first and second satellites configured to transmit respective first and second carrier signals with respective first and second phases to a location on earth, wherein:
the first and second satellites are configured to adjust the first and second phases based on a laser communication link between the satellites such that the first and second carrier signals will mutually reinforce at the location on earth; and
the first and second satellites, when transmitting the first and second carrier signals, maintain a position within a spatial cone having an apex at the location on earth and a base in space, wherein the size of the base determines a size of a footprint about the location on earth outside of which the first and second carrier signals do not mutually reinforce

20. The system of claim 19 comprising a third satellite configured to transmit a third carrier signals with a third phase to a location on earth,
wherein the third satellite is configured to adjust the third phase based on a laser communication link between the third satellite and the first satellite such that the third carrier signal mutually reinforces with the first carrier signal at the location on earth;
wherein the second satellite ceases to transmit the second carrier signal when the second satellite passes out of the cone; and
wherein the third satellite is configured to transmit the third carrier signal to the location on earth when the third satellite is entering the cone.
